(19) United States
(12) Patent Application Publication
(10) Pub. No.: US 2009/0135188 A1
(43) Pub. Date: May 28, 2009

(54) METHOD AND SYSTEM OF LIVE DETECTION BASED ON PHYSIOLOGICAL MOTION ON HUMAN FACE

(75) Inventors: Xiaoqing Ding, Beijing (CN); Liting Wang, Beijing (CN); Chi Fang, Beijing (CN); Changsong Liu, Beijing (CN); Liangrui Peng, Beijing (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TSINGHUA UNIVERSITY, Beijing (CN)

(21) Appl. No.: 12/129,708

(22) Filed: May 30, 2008

(30) Foreign Application Priority Data
Nov. 26, 2007 (CN) 200710178088.6

(51) Int. Cl. G06T 13/00

(52) U.S. Cl. 345/473

(57) ABSTRACT

A method and a system of live detection based on a physiological motion on a human face are provided. The method has the following steps: in step a, a motion area and at least one motion direction in visual angle of a system camera are detected and a detected facial region is found. In step b, whether a valid facial motion exists in the detected facial region is determined. If a valid facial motion is inexistent, the object is considered as a photo of human face, otherwise, the method proceeds to step c to determine whether the facial motion is a physiological motion. If not, the object is considered as the photo of human face, yet considered as a real human face. The real human face and the photo of human face can be distinguished by the present invention so as to increase the reliability of the face recognition system.

### CROSS-REFERENCE TO RELATED APPLICATION

This application claims the priority benefit of China application serial no. 200710178088.6, filed on Nov. 26, 2007. The entirety of the above-mentioned patent application is hereby incorporated by reference herein and made a part of specification.

### BACKGROUND OF THE INVENTION

1. Field of the Invention

The present invention relates to a field of face recognition. More particularly, the present invention relates to a method and a system of live detection based on a physiological motion on a human face.

2. Description of Related Art

In recent years, great progress on the technique of biometrics identification has been made, wherein common biometrics used include human face, fingerprint and iris, etc. These are widely used in the world for person identification. The discrimination of a genuine user and a counterfeit user can be made accurately through information contained in the biometrics. However, there are a lot of threats on biometrics identification such as login by fake facial photo, fake fingerprint or fake iris. The live detection of the biometrics identification system is thus developed for determining whether the biometrics submitted to the system is from a living individual to prevent a malicious login by stealing other people's biometrics. According to the advantages of the face recognition technology such as convenience and well acceptance by people, it is widely used in the aspect of identification, video monitoring and video data searching. But the threat on the security of face recognition technology needs to be solved before such technology can be put into practical application. Generally speaking, counterfeit login to the face identification system can be divided into the following categories: a photo of human face, a video fragment of human face, and a 3D face model, among which the human face photo is the easiest to obtain and is the most used in the counterfeit logins of the face identification system. In order to ensure the practical utility of the face identification system, a design of the live detection system is needed to prevent system login by photos of human face. The live detection on the human face and the face identification complement each other. Whether face identification can be used practically or not is determined by the maturity of the live detection technique.

In the field of live human face detection, there are three kinds of detecting methods. The first kind is to measure the 3D depth information through motion. The difference between a photo of human face and a real human face is that the real human face is a 3D object having depth information and the photo of human face is a 2D plane. Consequently, the real human face can be discriminated from the photo of human face by rebuilding the human face by 3D model and calculating the depth by motion. The disadvantage of this method is the difficulty in rebuilding the human face by 3D model, and the depth information can not be calculated accurately. The second kind of method is to analyze the percentage of the high-frequency weight corresponding to the photo of human face and the real human face. This method works on the assumption that the high-frequency information of the photo-human face is obviously less than that of the real human face. The foregoing problem exists in photos of human face with low resolution, but this method is unsuitable for photos with high resolution. The third kind of method is tracing the human face within the video sequences in real time and detecting the characteristic by specialized filter. This method divides the real human face and the photo of human face into two categories, and requires the design and training of specialized filter for each category. This method is time consuming, and the analysis on the differences in the existence of physiological motion between the real human face and the photo of human face is disregarded.

### SUMMARY OF THE INVENTION

Accordingly, the present invention is directed to a method and a system of live detection based on a physiological motion on a human face to simply and efficiently discriminate a real human face from a photo of human face so as to increase the reliability of a face recognition system.

The present invention is directed to a method of live detection based on a physiological motion on a human face. The method includes the following steps: in step a, a motion area and at least one motion direction of an object in visual angle of a system camera are detected and a detected facial region is found. In step b, whether a valid existence of a facial motion is in the detected facial region is determined. The object is considered to be a photo of human face if no valid existence of a facial motion is in the detected facial region. And if a valid existence of a facial motion is in the detected facial region, the method proceeds to step c to determine whether the facial motion is a physiological motion. The object is considered to be the photo of human face if the facial motion is not a physiological motion and considered to be a real human face if the facial motion is a physiological motion.

According to an embodiment of the present invention, the step b further includes step b1 and b2. In step b1, whether a consistent motion within a predetermined range exists outside of the detected facial region is determined. The object is considered to be the photo of human face if a consistent motion is existent. However, if a consistent motion is inexistent, the method proceeds to step b2 to determine whether the facial motion inside of the detected facial region is around the eyes and/or the mouth of the human face. If no, the object is considered to be the photo of human face, and if yes, the method proceeds to the step c.

According to an embodiment of the present invention, the step b1 further includes the following steps: in step d1, all motion directions in the motion area are gathered. Then, whether a difference between each of the motion directions is smaller than a predetermined angle is determined. If no, the consistent motion is determined as inexistent, and if yes, the consistent motion is determined as existent and the method proceeds to step d2 to calculate whether a central coordinate of the motion area is outside of the detected facial region and the motion area is greater than an area threshold. If yes, it is determined that the consistent motion within the predetermined range but outside of the detected facial region is existent.

According to an embodiment of the present invention, the step b2 further includes calculating a Euclidean distance between a central coordinate of the motion area and coordinates of the eyes and calculating a Euclidean distance between the central coordinates of the motion area and a coordinates of the mouth. The facial motion is determined as around the eyes and the mouth if the Euclidean distances are smaller than a distance threshold.

According to an embodiment of the present invention, the step b2 further includes calculating a Euclidean distance between a central coordinate of the motion area and a coordinate of the mouth. The facial motion is determined as around the mouth if the Euclidean distance is smaller than a distance threshold.

According to an embodiment of the present invention, the step b2 further includes calculating a Euclidean distance between a central coordinate of the motion area and coordinates of the eyes. The facial motion is determined as around the eyes if the Euclidean distance is smaller than a distance threshold.

According to an embodiment of the present invention, the step c further includes gathering all motion directions in the motion area, and considering the facial motion is a physiological motion if the motion directions are vertically opposite.

From another point of view, the present invention is directed to a system of live detection based on a physiological motion on a human face. The system includes a motion detecting module, a facial motion validating module and a physiological motion determining module. The motion detecting module is used for detecting a motion area and at least one motion direction of an object in visual angle of a system camera and finding a detected facial region. The facial motion validating module is used for determining whether a valid existence of a facial motion is in the detected facial region, and the physiological motion determining module is used for determining whether the facial motion in the detected facial region around the eyes and mouth of the human face is a physiological motion, wherein if no, the object is considered to be a photo of human face, and if yes, the object is considered to be a real human face.

According to an embodiment of the present invention, the facial motion validating module includes a consistent motion determining module and a facial motion area determining module. The consistent motion determining module is for determining whether a consistent motion within a predetermined range exists outside of the detected facial region, and considering the object to be the photo of human face if a consistent motion is existent. If a consistent motion is inexistent, the facial motion area determining module determines whether the facial motion inside of the detected facial region is around the eyes and mouth, or determines whether the facial motion inside of the detected facial region is around the mouth, or determines whether the facial motion inside of the detected facial region is around the eyes.

According to an embodiment of the present invention, the consistent motion determining module further includes an existence determining module and an area determining module. The existence determining module is for determining whether a difference between each of the motion directions in the motion area is smaller than a predetermined angle. If no, a consistent motion is considered as inexistent, and if yes, a consistent motion is considered as existent and the area determining module determines whether a central coordinate of the motion area is outside of the detected facial region and the motion area is greater than an area threshold. If yes, it is considered that a consistent motion within the predetermined range outside of the detected facial region is existent.

According to an embodiment of the present invention, the facial motion area determining module is an eyes-mouth-distance determining module, for respectively calculating a Euclidean distance between a central coordinate of the motion area and coordinates of the eyes and calculating a Euclidean distance between the central coordinate of the motion area and a coordinate of the mouth, and considering the facial motion is around the eyes and the mouth if the Euclidean distances are smaller than a distance threshold.

According to an embodiment of the present invention, the facial motion area determining module is a mouth-distance determining module for calculating a Euclidean distance between a central coordinate of the motion area and a coordinate of the mouth, and considering the facial motion is around the mouth if the Euclidean distance is smaller than a distance threshold.

According to an embodiment of the present invention, the facial motion area determining module is an eyes-distance determining module to calculate a Euclidean distance between a central coordinate of the motion area and coordinates of the eyes, and to consider the facial motion around the eyes if the Euclidean distance is smaller than a distance threshold.

According to an embodiment of the present invention, the physiological motion determining module is a motion direction determining module for gathering all motion directions in the motion area, and considering the facial motion as a physiological motion if the motion directions are vertically opposite.

In the present invention, real human face and photo of human face can be distinguished simply and efficiently so as to decrease the possibility of invasion on the face recognition system and increase the performance of live detection on the human face.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method of live detection based on a physiological motion on a human face according to an embodiment of the present invention.

FIG. 2 is a block diagram of a system of live detection based on a physiological motion on a human face according to an embodiment of the present invention.

FIG. 3 is a table of experimental results according to an embodiment of the present invention.

### DESCRIPTION OF EMBODIMENTS

Reference will now be made in detail to the preferred embodiments of the invention, examples of which are illustrated in the accompanying drawings. Wherever possible, the same reference numbers are used in the drawings and the description to refer to the same or like parts.

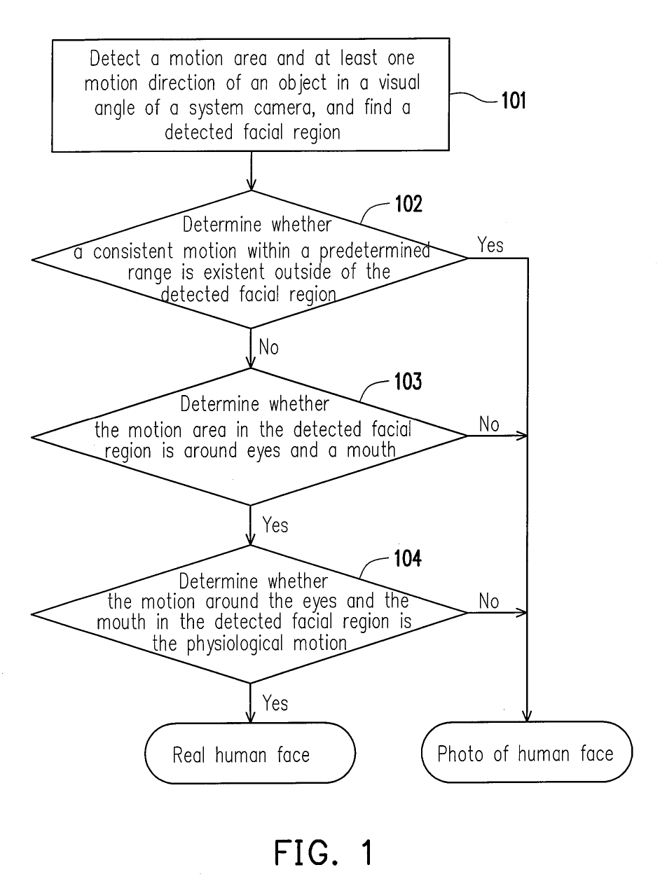

In a first embodiment of the present invention, a method of live detection based on a physiological motion on a human face are provided for distinguishing a real human face from a photo of human face. In the present method, the real human face and the photo of human face can be efficiently discriminated through the determination of physiological motion on the human face. FIG. 1 is a flow chart of the method. Referring to FIG. 1, in step 101, a motion area and at least one motion direction of an object in visual angle of a system camera are detected as well as a detected facial region is found. It is to be noted that the visual angle of a camera is sometimes known as camera perspective.

When processing a facial detection in the visual angle of the system camera, a rectangular region most alike the human face is detected for finding the detected facial region. The motion area of the object in the visual angle of the system camera can be detected by the difference of two adjacent perspective frames, in which the number of the motion area can be one or more than one. The motion directions of the object are detected by calculating a horizontal gradient and a vertical gradient so as to obtain a central coordinate, an area and the motion directions relative to each of the motion area in the visual angle of the system camera.

In step 102, whether a consistent motion within a predetermined range exists outside of the detected facial region is determined. The object is considered as the photo of human face if the foregoing consistent motion is existent. Otherwise the method proceeds to step 103.

The consistent motion means a motion to which all motion directions within the motion area are identical. After gathering all motion directions in the same motion area, the motion directions within the motion area are determined as the consistent motion if the included angle between each motion directions is smaller than 5 degrees. For each motion area, a distance from the central coordinate of the motion area to the detected facial region is calculated, and whether the motion area is greater than an area threshold (e.g. 30 to 50 pixels) is also calculated. It is determined that the consistent motion within the predetermined range outside of the detected facial region is existent if the central coordinate of the motion area is outside of the detected facial region and the motion area is greater than the area threshold.

In the circumstance where a real human keeps his or her head still, there is no consistent motion in the visual angle of the system camera besides on the human face in general. It is determined that the photo of human face is in the detected facial region if the consistent motion within the predetermined range outside of the detected facial region is detected. It may result in error rejection such as a background interference or people walking by when login by the real human face. However, a very low failure acceptance ratio (FAR) can be ensured to guarantee the security of the face recognition system. Moreover, a user can re-login after making adjustment once the error rejection has occurred.

In step 103, whether or not the motion area in the detected facial region is around eyes and mouth will be determined. The object is considered as the photo of human face if the motion area is not around the eyes and the mouth. Otherwise, the method proceeds to step 104.

Classification filters for the eyes and the mouth are designed by testing with a considerable quantity of human eyes and mouth samples. The tested classification filters for the eyes and the mouth are used for detecting eyes and mouth in the detected facial region and obtaining the coordinates thereof. A Euclidean distance from the central coordinate of the motion area to the eyes is calculated as well as a Euclidean distance from the central coordinate of the motion area to the mouth. The motion area is judged to be around the eyes and the mouth if the foregoing Euclidean distances are smaller than a distance threshold (e.g. 6 to 10 pixels). However, the object is considered as the photo of human face if the Euclidean distances are greater than the distance threshold.

Step 103 is necessary from the consideration of the system security. The object is considered as the photo of human face if there is no existence of any motion around the eyes and the mouth in the adjacent perspective frames.

In one embodiment, only the Euclidean distance from the central coordinate of the motion area to the eyes is calculated. And it is determined that the motion area is generated around the eyes if the Euclidean distance is smaller than the distance threshold (e.g. 6 to 10 pixels). Otherwise, the object is considered as the photo of human face.

In another embodiment, only the Euclidean distance from the central coordinate of the motion area to the mouth is calculated. And it is determined that the motion area is generated around the mouth if the Euclidean distance is smaller than the distance threshold (e.g. 10 to 15 pixels). Otherwise, the object is considered as the photo of human face.

In step 104, it is determined whether the motion generated around the eyes and the mouth in the detected facial region is a physiological motion. The object is considered as the photo of human face if the foregoing motion is not a physiological motion. And the object is considered as a real human face if the foregoing motion is a physiological motion.

The physiological motion includes physiologically facial motions such as blinking, talking or smiling, which are necessary movements for human beings. On the real human face, the motion generated around the eyes and the mouth is a motion encompassing a positional relationship that is related to opposite directions such as up and down. However, the motion simulated by the photo of human face does not have this kind of characteristic. The motion directions in each motion areas around the eyes and the mouth are determined whether they have a consistent direction or not. It is determined that the motion is not the physiological motion if the motion directions are consistent. For instance, the motion directions of the motion area around the eyes and the mouth are gathered first. Then, it is determined that the motion area has the vertically opposite motion if the motion directions in the motion area are in two main directions (e.g. a positive 90 degrees and a negative 90 degrees). As a result, the foregoing motion is the physiological motion so as to consider the object as the real human face.

In one embodiment, whether or not the motion of the mouth is the physiological motion will be determined to distinguish the real human face from the photo of human face. Since the details of the implementation are identical or similar to the above embodiment, the details will not be described herein again. In another embodiment, the discrimination of the real human face and the photo of human face can be made only by determining whether the motion of the eyes is the physiological motion. Similarly, the details identical or similar to the above embodiment will not be described herein.

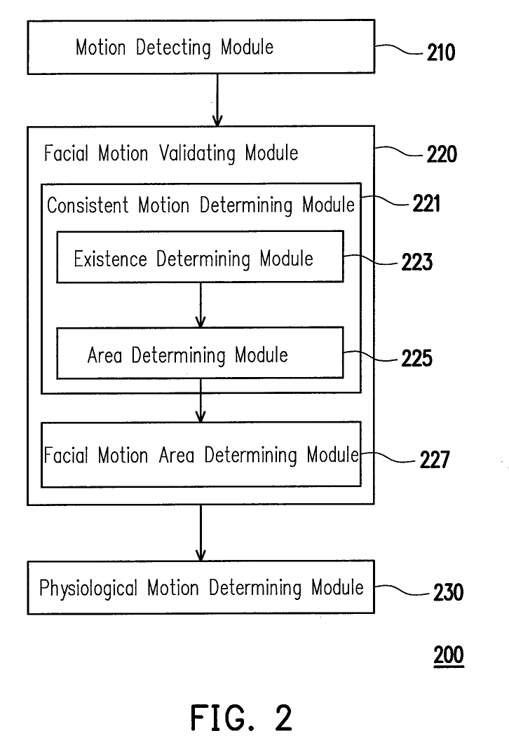

A second embodiment of the present invention is relative to a system of live detection based on a physiological motion on a human face as shown in FIG. 2. Referring to FIG. 2, the system 200 includes a motion detecting module 210, a facial motion validating module 220, and a physiological motion determining module 230. The motion detecting module 210 is used for detecting a motion area and motion directions of an object in visual angle of a system camera and for finding a detected facial region. The facial motion validating module 220 is used for determining whether a valid existence of a facial motion is in the detected facial region. The physiological motion determining module 230 is for determining whether the facial motion in the detected facial region around eyes and a mouth is physiological. If no, a detection result is considered as the photo of human face, and if yes, the detection result is considered as a real human face.

The facial motion validating module 220 comprises a consistent motion determining module 221 and a facial motion area determining module 227. The consistent motion determining module 221 is for determining whether a consistent motion within a predetermined range exists outside of the detected facial region. The object is considered as the photo of human face if the foregoing consistent motion is existent. And if the foregoing consistent motion is inexistent, the facial motion area determining module 227 determines whether the facial motion inside of the detected facial region is around the eyes and the mouth.

The consistent motion determining module 221 includes an existence determining module 223 and an area determining module 225. The existence determining module 223 is for determining whether a difference between each of the motion directions in the same motion area is smaller than a predetermined angle. If no, the consistent motion is determined as inexistent, and if yes, the consistent motion is determined as existent and the area determining module 225 is carries on to determine whether a central coordinate of the motion area is outside of the detected facial region and the motion area is greater than an area threshold, wherein if yes, the consistent motion within the predetermined range outside of the detected facial region is considered as existent.

The facial motion area determining module 227 is an eyes-mouth-distance determining module used for respectively calculating a Euclidean distance between a central coordinate of the motion area and coordinates of the eyes and calculating a Euclidean distance between the central coordinate of the motion area and a coordinate of the mouth. The facial motion is considered as around the eyes and the mouth if the Euclidean distances are smaller than a distance threshold.

In other embodiment, the facial motion area determining module 227 is a mouth-distance determining module which is suitable for calculating a Euclidean distance between a central coordinate of the motion area and a coordinate of the mouth. The facial motion is considered as around the mouth if the Euclidean distance is smaller than the distance threshold.

In another embodiment, the facial motion area determining module 227 is an eyes-distance determining module, for calculating the Euclidean distance between a central coordinate of the motion area and coordinates of the eyes. And the facial motion is considered as around the eyes if the Euclidean distance is smaller than the distance threshold.

The physiological motion determining module 230 is a motion direction determining module which is used for gathering all motion directions in the motion area, and considering the facial motion is a physiological motion if the motion directions in the same motion area are vertically opposite.

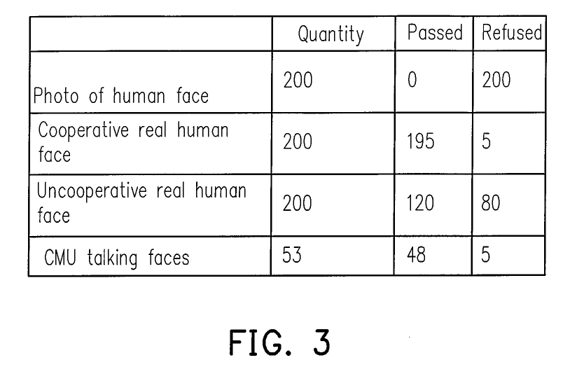

The following experiment shows the performance of the embodiments according to the present invention. A database with a series of 400 real human faces and a series of 200 photos of human face is constructed for the experiment. The series of 400 real human faces is further divided into two types, cooperative real human faces and uncooperative real human faces. In the cooperative real human faces, each head is motionless and the facial motion is only generated by habitual blinking or talking. In the uncooperative real human faces, arbitrary motions such as turning or raising one's head in front of the camera can be found. The distance between two eyes is from 25 to 100 pixels and the size of each picture is 240×320. In addition, 53 talking faces from the CMU Pose, Illumination, and Expression Database are also tested in the experiment. The talking faces belong to the cooperative real human face type; the distance between eyes is about 100 pixels, and the size of the picture is 486×670. The experimental results are shown in FIG. 3.

As shown in FIG. 3, the passing ratio of the cooperative real human face type is extremely higher than the uncooperative real human face type. A certain cooperation of a user is necessary to ensure the low passing ratio of the series of photos of human face. To guarantee the security of the biometrics identification system, it is better to refuse all fabricated bio-characteristics such as the photo to pass through the system, and thus a very low FAR is required. Since human beings have lively characteristics that can make certain cooperation, the invasion of the system can be reduced.

The live detection is an important and non-dividable part of the face recognition system, whether the face recognition system can be applied practically is determined by the performance of the live detection on human face. Through the present invention, the real human face and the photo of human face can be discriminated so as to decrease the possibility of system invasion and increase the performance of the live detection on human face.

On the other hand, there are many ways to login the face identification system as a counterfeit, for example, a recorded video as well as the photo is usually used for system login. In order to deal with the circumstance of using the video to login the system, the examination on the motion such as blinking, talking and mouth opening of the user and the usage of an interactive instruction to ask the user to cooperatively open mouth, close eyes or give a talk in real time are used for examining the reaction of the user so as to make the relative decision.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of live detection based on a physiological motion on a human face, the method comprising:
a. detecting a motion area and at least one motion direction of an object in visual angle of a system camera and finding a detected facial region;
b. determining whether a valid existence of a facial motion is in the detected facial region, wherein if it isn't, the object is considered as a photo of human face, and if it is, the method proceeds to a step c.; and
c. determining whether the facial motion in the detected facial region is a physiological motion, wherein if it isn't, the object is considered as the photo of human face, and if it is, the object is considered as a real human face.

2. The method as claimed in claim 1, wherein the step of determining whether a valid existence of the facial motion is in the detected facial region further comprises:
b1. determining whether a consistent motion within a predetermined range exists outside of the detected facial region, wherein if yes, the object is considered as the photo of human face, and if no, the method proceeds to a step b2.; and
b2. determining whether the facial motion inside of the detected facial region is around the eyes and mouth of the human face, wherein if no, the object is considered as the photo of human face, and if yes, the method proceeds to the step c., or
determining whether the facial motion inside of the detected facial region is around the mouth of the human face, wherein if no, the object is considered as the photo of human face, and if yes, the method proceeds to the step c., or
determining whether the facial motion inside of the detected facial region is around the eyes of the human face, wherein if no, the object is considered as the photo of human face, and if yes, the method proceeds to the step c.

3. The method as claimed in claim 2, wherein the step of determining whether a consistent motion within a predetermined range exists outside of the detected facial region further comprises:
d1. gathering all motion directions in the motion area, and determining whether a difference between each of the motion directions is smaller than a predetermined angle, wherein if no, the consistent motion is considered as inexistent, and if yes, the consistent motion is considered as existent and the method proceeds to a step d2.; and
d2. determining whether a central coordinate of the motion area is outside of the detected facial region and the motion area is greater than an area threshold, wherein if yes, the consistent motion within the predetermined range outside of the detected facial region is considered as existent.

4. The method as claimed in claim 2, wherein the step of determining whether the facial motion inside of the detected facial region is around the eyes and the mouth of the human face further comprises:
respectively calculating a Euclidean distance between a central coordinate of the motion area and coordinates of the eyes, and calculating a Euclidean distance between the central coordinate of the motion area and a coordinate of the mouth, and considering the facial motion is around the eyes and the mouth if the Euclidean distances are smaller than a distance threshold.

5. The method as claimed in claim 2, wherein the step of determining whether the facial motion inside of the detected facial region is around the mouth of the human face further comprises:
calculating a Euclidean distance between a central coordinate of the motion area and a coordinate of the mouth, and considering the facial motion is around the mouth if the Euclidean distance is smaller than a distance threshold.

6. The method as claimed in claim 2, wherein the step of determining whether the facial motion inside of the detected facial region is around the eyes of the human face further comprises:
calculating a Euclidean distance between a central coordinate of the motion area and coordinates of the eyes, and considering the facial motion is around the eyes if the Euclidean distance is smaller than a distance threshold.

7. The method as claimed in claim 1, wherein the step of determining whether the facial motion in the detected facial region is a physiological motion further comprises:
gathering all motion directions in the motion area, and considering the facial motion is a physiological motion if the motion directions are vertically opposite.

8. A system of live detection based on a physiological motion on a human face, comprising:
a motion detecting module, for detecting a motion area and at least one motion direction of an object in visual angle of a system camera and finding a detected facial region;
a facial motion validating module, for determining whether a valid existence of a facial motion is in the detected facial region; and
a physiological motion determining module, for determining whether the facial motion in the detected facial region around the eyes and mouth of the human face is a physiological motion, wherein if no, the object is considered as a photo of human face, and if yes, the object is considered as a real human face.

9. The system as claimed in claim 8, wherein the facial motion validating module further comprises:
a facial motion area determining module; and
a consistent motion determining module, for determining whether a consistent motion within a predetermined range exists outside of the detected facial region, wherein if yes, the object is considered as the photo of human face, and if no, the facial motion area determining module carries on to determine whether the facial motion inside of the detected facial region is around the eyes and the mouth of the human face, or whether the facial motion inside of the detected facial region is around the mouth of the human face, or whether the facial motion inside of the detected facial region is around the eyes of the human face.

10. The system as claimed in claim 9, wherein the consistent motion determining module further comprises:
an area determining module; and
an existence determining module, for determining whether a difference between the motion directions in the motion area is smaller than a predetermined angle, wherein if no, the consistent motion is considered as inexistent, and if yes, the consistent motion is considered as existent and the area determining module carries on to determine whether a central coordinate of the motion area is outside of the detected facial region and the motion area is greater than an area threshold, wherein if yes, the consistent motion within the predetermined range outside of the detected facial region is considered as existent.

11. The system as claimed in claim 9, wherein the facial motion area determining module is an eyes-mouth-distance determining module, for respectively calculating a Euclidean distance between a central coordinate of the motion area and coordinates of the eyes and calculating a Euclidean distance between the central coordinate of the motion area and a coordinate of the mouth, and considering the facial motion is around the eyes and the mouth if the Euclidean distances are smaller than a distance threshold.

12. The system as claimed in claim 9, wherein the facial motion area determining module is a mouth-distance determining module, for calculating a Euclidean distance between a central coordinate of the motion area and a coordinate of the mouth, and considering the facial motion is around the mouth if the Euclidean distance is smaller than a distance threshold.

13. The system as claimed in claim 9, wherein the facial motion area determining module is an eyes-distance determining module, for calculating a Euclidean distance between a central coordinate of the motion area and coordinates of the eyes, and considering the facial motion is around the eyes if the Euclidean distance is smaller than a distance threshold.

14. The system as claimed in claim 8, wherein the physiological motion determining module is a motion direction determining module, for gathering all motion directions in the motion area, and considering the facial motion as a physiological motion if the motion directions are vertically opposite.
